(19) United States
(12) Patent Application Publication
(10) Pub. No.: US 2007/0057806 A1
(43) Pub. Date: Mar. 15, 2007

(54) High-intensity long-distance status annunciation apparatus and method

(75) Inventor: Robert Leonard Nelson JR., Williamson County, TX (US)

Correspondence Address: ALTERA LAW GROUP, LLC, 6500 CITY WEST PARKWAY, SUITE 100, MINNEAPOLIS, MN, 55344-7704, US

(73) Assignee: Raven Industires, Inc., Sioux Falls, SD (US)

(21) Appl. No.: 11/224,433

(22) Filed: Sep. 12, 2005

(51) Int. Cl. G08B 5/00

(52) U.S. Cl. 340/815.4

(57) ABSTRACT

A high-intensity visual light indicates the operating status of outdoor equipment generally and agricultural equipment specifically. In one aspect, the indicator light provides long-distance visual diagnostic annunciation of the equipment's status using visual patterning indicative of the operating condition of the machine. Thus, the indicator light may provide information regarding a plurality of normal operating conditions for the equipment, beyond simply whether power is present or lacking. Additionally, in the event that the equipment is not working properly, the indicator light may provide information regarding the particular anomaly involved. The indicator light may be a single color, for example, white, that is capable of patterned flashing to indicate status. The high-intensity light may be, in a preferred embodiment, a xenon strobe. A logic circuit may be employed to create the desired flash sequence. The inputs to the circuit may be adapted to any signal specification, including any conventional electronic logic levels and relay or switch contacts or they may be driven by de-serialized digital communication signals to facilitate interfacing with a programmed digital computer or other device. The logical functions may be programmed into a digital computer. The flashing pattern may be augmented by the use of color, so that a combination of colors and flashing patterns indicate the equipment's status.

### FIELD OF THE INVENTION

This invention relates generally to a high-intensity status indicator apparatus and method for long distance annunciation of the operating status of outdoor equipment.

### BACKGROUND OF THE PRESENT INVENTION

It is commonplace for highly automated equipment, such as a furnace or an automobile, to signal its status by flashing a light in a coded pattern. By way of example, perhaps the most common use involves the flashing oil or “check engine” indicator in an automobile. In this manner, complex equipment is able to provide diagnostic data when required using a very minimal display comprising, for example, a single signal light, such as a light-emitting diode. However, this type of diagnostic light and the data transmitted by it are, by definition, limited to short-distance visualization.

In addition, rhythmically flashing warning lights have long been available for uses such as on police vehicles, emergency vehicles, and warning barricades or other highway uses. Similarly, aircraft use flashing lights to indicate position because they are, by law, required to be visible at distances of several miles. Watercraft are also required to have multiple navigational and identifying lights. Such lights include bow lights, placed at the bow of a boat, and running lights that are bright lights that may be seen up to a distance of a mile or more. Though this configuration of lights works to advise other boaters of a boat's position, the lights are not capable of providing indication of status of the vessel itself. Bow lights are typically oriented to cast light in a single direction and generally forward from the light source and the boat. Thus, bow lights are ineffective in providing illumination in the 360-degree fashion that would be required by an outdoor-equipment status indicator. Moreover, the running lights, though bright and perhaps operational in 360-degree fashion, are incapable of being manipulated to provide long-distance flashing indication of vessel status. Some such warning lights do not provide status indication because they typically comprise a bright light surrounded by a rotating mirror that gives the illusion of a flashing light as the mirror rotates around the light. The mirror's rotation may be increased or decreased, but the light assembly cannot be easily or readily modified to indicate various diagnostic states of the vehicle.

This type of rotating-mirror light has now been largely supplanted by xenon flashtubes, which, however, mimic the rhythmic flashing patterns of the earlier type. These are similar to the flashtubes used for flash photography. This type of light is, again, a warning device and, as such, is constructed to flash rhythmically. Thus it is incapable of providing a highly visible indication of status through use of flashing patterns.

Colored lights, whether steady or flashing, have long been used to convey information such as the status of equipment. The use of color has the distinct disadvantage however of requiring multiple lights or a means of changing the color of an individual light in order to modify the message sent. Furthermore, the number of distinct colors that can be identified is severely limited by human physiology to perhaps half a dozen at the very most.

Given the above, as outdoor equipment, for example, agricultural equipment, becomes more automated, there is a corresponding need for a simple and robust means for indicating the status of the equipment. Because the equipment is operating outdoors, often with long distances interposed between the equipment and observers, such as operators and maintainers, as in the case of agricultural fieldwork, it is highly desirable that the status indication be capable of long-distance annunciation.

Thus there exists a need for a high-intensity and robust indicator light for long-distance annunciation of operating status of agricultural and other outdoor equipment. The present invention meets this need.

### SUMMARY OF THE INVENTION

A high-intensity visual light indicates the operating status of outdoor equipment generally and agricultural equipment specifically. In one aspect, the indicator light provides long-distance visual diagnostic annunciation of the equipment's status using visual patterning indicative of the operating condition of the machine. Thus, the indicator light may provide information regarding a plurality of normal operating conditions for the equipment, beyond simply whether power is present or lacking. Additionally, in the event that the equipment is not working properly, the indicator light may provide information regarding the particular anomaly involved. The indicator light may be a single color, for example, white, that is capable of patterned flashing to indicate status. The high-intensity light may be, in a preferred embodiment, a xenon strobe. A logic circuit may be employed to create the desired flash sequence. The inputs to the circuit may be adapted to any signal specification, including any conventional electronic logic levels and relay or switch contacts or they may be driven by de-serialized digital communication signals to facilitate interfacing with a programmed digital computer or other device. The logical functions may be programmed into a digital computer. The flashing pattern may be augmented by the use of color, so that a combination of colors and flashing patterns indicate the equipment's status.

An object of the invention is to provide a device and method for long-distance visual annunciation of equipment status.

Another object of the invention is to provide a device and method that provides long-distance visual annunciation of diagnostic or status information or both relating to equipment status.

Another object of the invention is to provide a device and method that provides long-distance visual annunciation of diagnostic or status information or both for at least one specific component of a piece of equipment.

Yet another object of the invention is to provide a device and method that provides long-distance visual annunciation of diagnostic information or status or both of equipment or components or both through high-intensity flashing sequences.

The foregoing objects of various embodiments of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is simplified block diagram of an embodiment of the inventive apparatus.

FIG. 2 is a simplified schematic diagram of one embodiment of an electrical circuit for the inventive apparatus.

FIG. 3 is a timing diagram correspondent to the schematic diagram of FIG. 2.

### DETAILED DESCRIPTION OF THE INVENTION

In accordance with a preferred embodiment of the present invention, a high-intensity light that indicates the operating status of outdoor equipment is provided. In a preferred embodiment, the indicator light provides long-distance visual annunciation of diagnostic or status information, or both, by using a visual pattern, sequence or syntax that corresponds to at least one operating condition of the equipment. Thus, the indicator light may provide information regarding a plurality of operating conditions for the equipment, including but not limited to the relative severity of any abnormalities or anomalies that may exist.

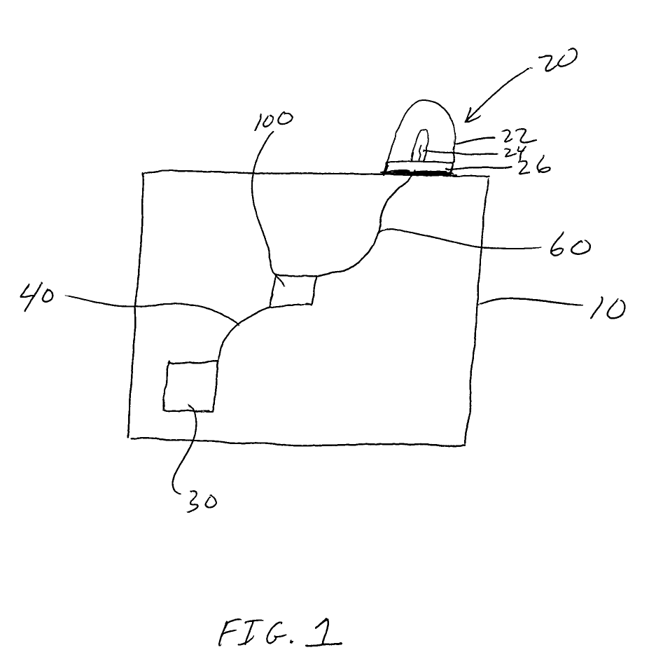

Equipment 10 is illustrated with a flasher assembly 20 disposed thereon in FIG. 1. The flasher assembly 20 may comprise a substantially transparent housing 22, surrounding or encasing at least one illumination element 24 with a base 26 wherein the base secures the illumination element 24 and houses the necessary electrical wiring to power the illumination element 24. The illumination element 24 is generally disposed within the housing 22. In certain embodiments, the base 26 may be used to provide support for the illumination element 24 and/or as a mechanism for securing the attachment of the apparatus to the equipment 10.

The flasher assembly 20 may be attached to the machine 10 by a base 26 or housing 22. The attachment mechanism of the base 26 or housing 22 to the machine 10 may be accomplished by any number of methods well known in the art, including but not limited to bolts, screws, welding, magnetic attachment and the like. The device may be designed to be a separate component or may alternatively be integrated into the equipment's design.

The housing 22 is preferably quite robust to withstand outdoor weather conditions and the illumination element 24 may preferably be a xenon strobe. Alternatively, the flasher assembly 20 may consist of the at least one illumination element 24 and a base 26 without a housing 22, wherein the illumination element 24 is itself sufficiently robust and rugged to withstand outdoor weather elements.

Additionally, the housing material must allow the illumination element 24 to provide long-distance annunciation of operating status. Thus, the housing material must be sufficiently transparent or translucent so that light from the actuated or flashing illumination element 24 may pass through the housing 22 to the extent appropriate for long-distance status annunciation. With these minimum criteria in mind, representative housing materials include, inter alia, various glasses, plastics, polymer compounds, and/or plexiglass to name a few. Many suitable housing materials are commercially available, and any material that is sufficiently durable and waterproof may be suitable for use in the invention.

The subject equipment or machinery 10 is shown in FIG. 1 with a flash signal output element 30 integrated within the equipment 10. There may be a plurality of such elements 30 integrated within a given machine or piece of equipment, including any machine component or system capable of outputting a status signal. It is within the scope of the invention to receive this status signal, process it and transmit long-distance visual annunciation of certain operational, diagnostic and/or status information for such elements 30. For example, and without limitation, a particular flash signal output element may provide diagnostic and/or status information regarding oil pressure, fuel level, battery level, electrical system, hydraulic system, or simply whether power is present or not present. Various embodiments of the present invention process this information, transforming it into a coded flash sequence.

The illumination element 24 may comprise at least one very bright light, xenon strobe or other high-intensity light source. In some embodiments, a plurality of light sources may be used, wherein the coordinated and coded flashing of more than one light source is utilized to convey information regarding certain operational status and/or diagnostic conditions of a plurality of elements 30, e.g., components or systems, within the equipment 10. Moreover, such bulbs may be color-coded to provide additional information, e.g., indication of relative severity of a particular condition or the combination of identification of a particular component or system within the machine by a specific color combined with coded flashing sequencing. By way of example, two flashes a second may represent or indicate low fuel level in general. Two flashes a second with a green bulb may indicate a relatively low severity, two flashes a second with a yellow bulb may indicate a moderate severity and two flashes a second with a red bulb may indicate that the machine or equipment is about to run out of fuel. This exemplifies a form of long-distance annunciation using nested coding that is made possible by the inventive device and method.

Still another exemplary implementation may include a nested coding approach to (1) identify a particular system element 30; and (2) provide diagnostic and/or status information about the identified element 30. For example, two sequential flashes, perhaps one long and the second relatively short, may indicate that some portion of the equipment may require lubrication. The system-element-identifying flashes may be followed by the actual diagnostic and/or status flash code sequence, providing additional specificity to the coded flash information. Thus, two long flashes in sequence may indicate that lubrication of the equipment gearbox is required. Thus, the exemplary nested code flash sequence may comprise four repeating sequential flash sequences:
long flash—short flash (lubrication generally), followed by
long flash—long flash (gearbox lubrication).

Thus, numerous possibilities and combinations of flash variables for communication of diagnostic and/or status information readily present themselves to those skilled in the art. Using this information, it is possible, for example, to use the inventive device to direct flashing sequences using a known coding sequence or syntax such as Morse code to communicate complex information. Possible flash sequencing encoding variables include, inter alia, the number of flashes in a sequence, the relative length of each flash within a sequence, the spacing of time between flashes, the color of the flash, the numbers of illumination elements 24 or bulbs used, etc.

Continuing now with reference to FIG. 1, the flash signal output element 30 is illustrated as being in operative communication with a flasher controller 100 via communication line 40. It is through this operative communicative connection that status and/or diagnostic information is transmitted or communicated from the flash signal output element 30 to the flasher controller 100. Those skilled in the art will readily recognize that certain embodiments may communicate the status and/or diagnostic information from the flash signal output element 30 to the flasher controller 100 in wireless fashion using wireless methods and mechanisms that are well known to those skilled in the art. Thus, the invention is not limited to wired communication between the flash signal output element 30 and the flasher controller 100.

FIG. 1 further illustrates a line 60 through which flash control signals are transmitted from the flasher controller 100 to the flasher assembly 20, specifically to the illumination element 24 within the flasher assembly 20, which may in turn cause the at least one illumination element 24 to flash in coded sequence. As above, the communication of flash control signals from the flasher controller 100 to the flasher assembly 20 and the at least one illumination element 24 may occur using well-known wired communication mechanisms. Thus, this aspect of the inventive device is not limited to wired communication between the flasher controller 100 and flasher 20 and illumination element 24.

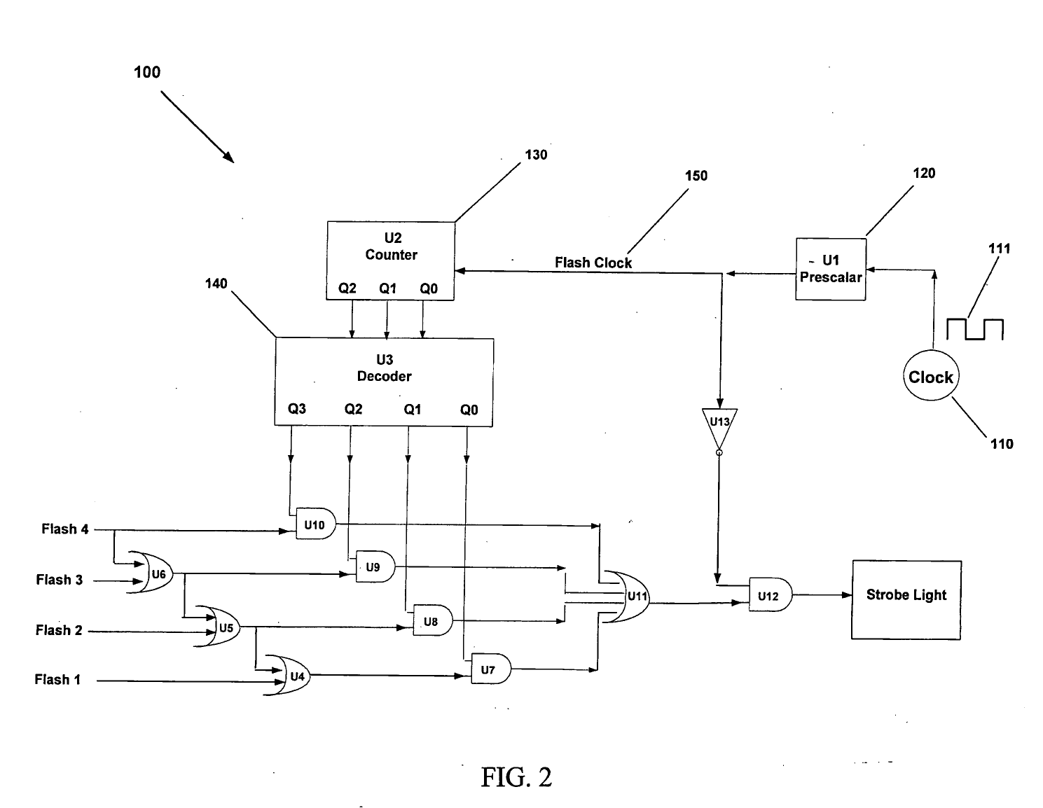

Referring now to FIG. 2, one embodiment of the flasher controller 100 is depicted schematically in FIG. 1. As shown, the exemplary four inputs to the circuitry, Flash 1 through Flash 4, may each independently represent a particular operational status of a device in a remote location. Also, there may exist a hierarchy in the status indicator inputs wherein a higher flash number may represent a more critical parameter or condition present in the remote device. For example, Flash 1 may represent the remote device is operating normally, whereas the other extreme may be Flash 4, where the device has malfunctioned and needs immediate repair or servicing. It will be appreciated that for complex instruments or machinery, additional flash numbers (above and beyond four) may be needed and the present invention is amenable to such cases. In the present embodiment, an electrical input signal, Flash 1, may initiate flashing a high intensity strobe light once every few seconds—Flash 2 may initiate two flashes every few seconds and so on. No flash may indicate catastrophic equipment failure, lack of power or the like or, alternatively, may indicate that there are no problems with the monitored components and/or systems.

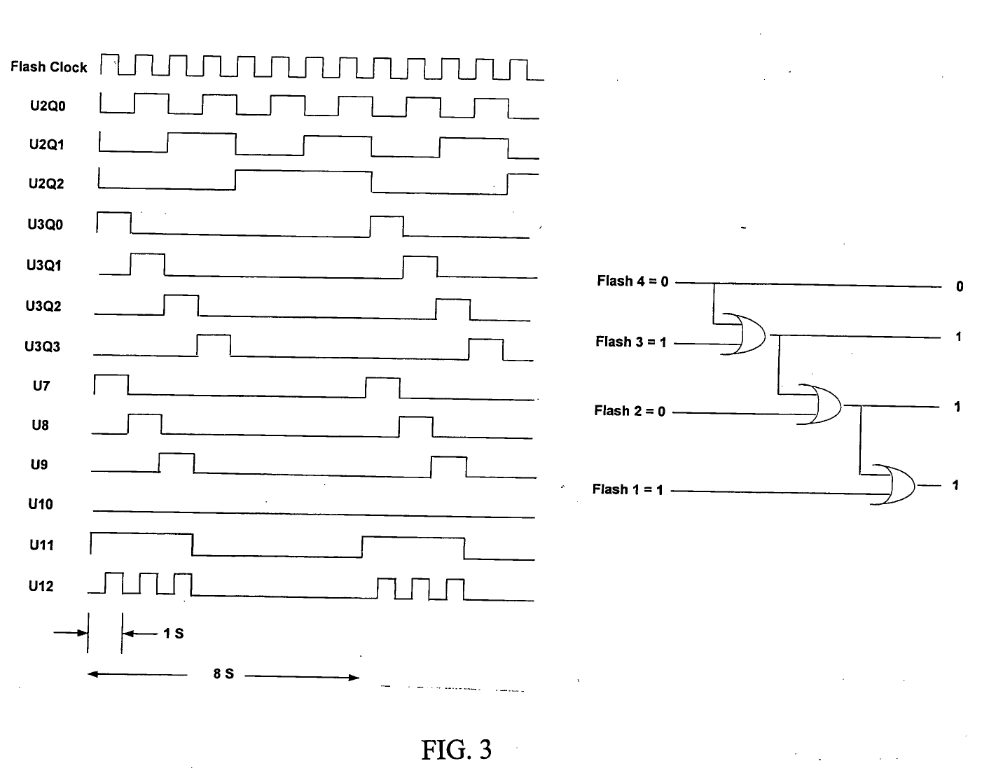

FIG. 3 provides the timing diagram that corresponds with the schematic of FIG. 2 and illustrates the response of the overall device to the following input set:
Flash 1=1
Flash 2=0
Flash 3=1
Flash 4=0

As shown in the embodiment illustrated in FIGS. 2 and 3, Flash 3 is assigned a higher priority input signal and thus dictates the response of the flashing of the high intensity light. In this case, the light will flashes 3 times in accordance with the signal provided by U12 at a 1 hertz rate repeating every 8 seconds. Note that Flash 4 input is digitally 0. Thus, the next higher priority signal controls; in this case Flash 3 is the next highest priority signal with a digital value of 1. The internal workings of the electrical circuitry to realize this output will be explained below.

Inputs to the circuit are indicated as Flash 1, Flash 2, Flash 3 and Flash 4 and are fixed throughout the timing sequence as provided above and as illustrated in FIG. 3. The inputs to the exemplary circuit embodiment shown in FIG. 2, i.e., Flash 1 through Flash 4, may be adapted to any signal specification, including any conventional electronic logic levels and relay or switch contacts. Alternatively, the input signals may be driven by de-serialized digital communication signals to facilitate data input interfacing with a programmed digital computer or other device. Such data input interface may be operatively coupled to the programmed digital computer's processor and memory components. Moreover, the programmed digital computer may have a data output interface for providing the coded sequence flash signals to the illumination element, e.g., very bright bulb or xenon strobe. The data output interface may be operatively coupled to the programmed digital computer's processor and memory.

Referring now to FIG. 2, the internal timing sequences of the high intensity light status indicator flash control 100 are controlled by the internal clock generator 110 in conjunction with the clock prescaler 120, the counter 130, and the decoder unit 140. The clock generator 110 may output a square wave signal 111 at a nominal frequency which may need to be reduced to a value acceptable for the human eye to discern, which may be accomplished by the clock prescaler 120. The clock prescaler 120 may output a square wave signal Flash Clock 150 at a reduced frequency, shown as 1 Hertz in FIG. 2. The Flash Clock signal 150 clocks the counter unit 130 such that its repetitive period is, for example, 8 seconds in this embodiment. The decoder unit 140 in return outputs/decodes the first four states of the counter unit 130, as shown in signals U3Q0 through U3Q3.

The representative inputs, Flash 1 through Flash 4, may first encounter OR gates U4, U5 and U6 in the embodiment provided in the FIG. 2. The OR gates may function to combine Flash inputs as shown in FIG. 2 to create intermediate logic signals, a number of which may be asserted according to the number assigned to the highest-numbered of the Flash inputs. In other words, if Flash 4 is asserted, the outputs of all 3 gates U4 through U6 as well as Flash 4 are asserted. Alternatively, if Flash 3 is asserted, the outputs of all 3 gates U4 through U6 may be asserted. Similarly, if Flash 2 is asserted, the outputs of gates U4 and U5 are asserted and if Flash 1 is asserted, the output of gate U4 only may be asserted. If there is no Flash input, no intermediate signal will be asserted.

As further illustrated by FIG. 2, AND gates U7, U8, U9, and U10 may function to combine the intermediate signals with the decoded counter states Q0, Q1, Q2 and Q3, to produce a logic signal at the output of U11 which is asserted for a number of counter states out of each counter period corresponding to the number assigned to the highest-numbered Flash input asserted. U12 may then “and” this signal with the inverted flashclock signal from U13 to produce that same number of pulses to trigger the Strobe Light during each counter period.

Given the representative inputs illustrated in FIG. 3 and as provided above, for Flash 1 through Flash 4, the outputs of AND gates U7 through U9 sequentially step through three cycles repeating every 8 seconds. This sequencing will eventually flash the high intensity strobe light 3 times at a 1 hertz rate repeating every 8 seconds in the illustrated embodiment. Note that U10 stays at a digital state zero in this example, this is due to input signal Flash 4=0. If however, Flash 4 had been asserted (i.e., Flash 4=1), the output of U7 through U10 would accordingly sequentially step through four cycles repeating every 8 seconds.

Note that the OR gates U4 through U6 may be replaced by AND gates or logic to alter the priority from the highest-numbered (highest priority) to the lowest-numbered (lowest priority) of the flash inputs if desired.

Continuing with the exemplary embodiment of FIGS. 2 and 3, the outputs of U7 through U10 are combined at the input of OR gate U11, whose output stays high for 3 seconds. The output of U11 and U13 (the inverted Flash Clock 150 signal) are inputted to AND gate U12 yielding an output signal firing the high intensity strobe light 3 times at a 1 hertz rate repeating every 8 seconds.

As discussed above, the inputs to the exemplary circuit, Flash 1, Flash 2, Flash 3, and Flash 4, may be configured to facilitate interfacing with a programmed digital computer having a processor, a memory operatively coupled to the processor, a data input interface operatively coupled to the processor and memory, and a data output interface operatively coupled to the processor and memory. Thus, the logical functions described in connection with FIGS. 2 and 3 may be readily programmed using computer code into a digital computer, stored within the computer's memory and executed by the computer's processor or embodied in a computer program product.

Alternative embodiments may be realized by selection of a suitable clock 110 frequency, prescaling ratio, number of counter U2 states, and the decoder U3 range, the flash controller 100 may be configured to vary a number of elements, including, inter alia, the flashing rate, the interval between groups of flashes, the different numbers of flashes able to be produced within each group. Moreover, the counter U2 and decoder U3 may be expanded so that two or more sets of counter states may be associated with corresponding sets of flash inputs to allow encoding of multiple items of data into successive groups of flashes, with any pattern or syntax desired in the spacing among the groups.

As discussed above, the inventive device and method may comprise one or more illumination elements 24, wherein the coded flashing of the more than one illumination element 24 is utilized to convey information regarding certain operational status conditions of a plurality of elements 30, e.g., components or systems, within the equipment 10. Moreover, some, or all, of the illumination elements 24 may be color-coded to provide indication of relative severity of a particular condition or the combination of identification of a particular component or system within the machine by a specific color with coded flashing sequencing to indicate status. Still another embodiment may include illumination elements 24 that flash with different brightness levels to communicate status and/or diagnostic information.

In various embodiments, the inventive device may include transceiver functionality whereby one or two-way wired or wireless communication may be accomplished between the device and a remote location, e.g., the location where the maintainer and/or observer is located. Such communication may, e.g., consist of signaling that indicates, e.g., fuel level or oil level is low in the equipment. The observer may query the device as to the estimated time left to operate before running out of fuel, or the estimated levels of fuel and/or oil, or an estimate of how much fuel and/or oil may be added. In response the device may answer the observer's query, allowing the observer to plan maintenance accordingly.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A status indicator for long distance annunciation of the operating status of at least one article of outdoor equipment, the equipment having at least one signal output element, comprising:
a base, the base operatively attached to the at least one article of outdoor equipment;
at least one illumination element secured to the base; and
a flasher controller in communication with the at least one signal output element and the at least one illumination element, wherein the flasher controller receives at least one input signal from the at least one signal output element and signals the at least one illumination element to flash in at least one coded sequence to provide an observer located remotely from the equipment with visual diagnostic and/or status information about at least one operating condition for the at least one signal output element and in accordance with the at least one input signal.

2. The status indicator of claim 1, further comprising a protective housing surrounding the at least one illumination element and further secured to the base.

3. The status indicator of claim 2, wherein the housing further comprises a substantially transparent material.

4. The status indicator of claim 1, wherein the at least one illumination element comprises at least one xenon strobe.

5. The status indicator of claim 1, wherein the at least one illumination element further comprises at least two bulbs that vary in brightness when flashed.

6. The status indicator of claim 1, wherein the at least one illumination element further comprises at least two bulbs with different colors when flashed.

7. The status indicator of claim 1, wherein the at least one illumination element further comprises at least two bulbs that vary in brightness when illuminated and at least two bulbs with different colors when illuminated.

8. The status indicator of claim 1, the flasher controller further comprising a circuit, wherein the circuit receives the at least one input signal, processes the at least one input signal and generates a signal sequence, wherein the at least one illumination element is signaled to flashed according to the signal sequence.

9. The status indicator of claim 8, the circuit further comprising the capability of establishing a hierarchy in the at least one input signal, wherein each input signal is prioritized and the input signal having the highest priority is the input signal used to generate the signal sequence that is used to signal the at least one illumination element to flash in coded sequence.

10. The status indicator of claim 8, the circuit further comprising the capability of establishing a hierarchy in the at least one input signal, wherein each input signal is prioritized and the input signal having the lowest priority is the input signal used to generate the signal sequence that is used to signal the at least one illumination element to flash in coded sequence.

11. The status indicator of claim 1, further comprising a digital computer in communication with the at least one output signal element and the at least one illumination element, wherein the digital computer receives the at least one input signal and is further programmed to signal the at least one illumination element to flash in the at least one coded sequence.

12. The status indicator of claim 11, further comprising a computer program product wherein instructions are provided to signal the at least one illumination to flash the at least one illumination element in the at least one coded sequence.

13. The status indicator of claim 12, wherein the computer program product establishes a hierarchy in the at least one input signals, wherein each input signal is given a priority and the input signal having the highest priority is the input signal used to generate the signal sequence that is used to signal the at least one illumination element to flash in coded sequence.

14. The status indicator of claim 12, wherein the computer program product establishes a hierarchy in the at least one input signals, wherein each input signal is given a priority and the input signal having the lowest priority is the input signal used to generate the signal sequence that is used to signal the at least one illumination element to flash in coded sequence.

15. The status indicator of claim 1, wherein the flasher controller communication with the at least one signal output element and the at least one illumination element comprises wired and/or wireless communication.

16. The status indicator of claim 1, wherein the at least one coded sequence includes variables selected from the group consisting of: the number of flashes, the relative length of each flash, the spacing of time between flashes, the color of the flash, and the relative brightness of each flash.

17. The status indicator of claim 1, wherein the at least one coded sequence comprises nested coding.

18. A flasher controller for controlling long distance annunciation of the operating status of at least one article of outdoor equipment by generating a coded sequence for flashing at least one illumination element disposed in proximity to the equipment for providing status and/or diagnostic information of at least one component or system of the equipment to an observer at a remote location, comprising:
a circuit, wherein the circuit receives at least one input signal from the at least one component or system, processes the at least one input signal and generates the coded sequence of flashing, wherein the at least one illumination element is flashed according to the coded sequence.

19. The flasher controller of claim 18, the circuit further comprising the capability of establishing a hierarchy in the at least one input signal, wherein each input signal is assigned a priority and the input signal with the highest priority is the input signal used to generate the coded sequence used to flash the at least one illumination element.

20. The flasher controller of claim 18, the circuit further comprising the capability of establishing a hierarchy in the at least one input signal, wherein each input signal is assigned a priority and the input signal with the lowest priority is the input signal used to generate the coded sequence used to flash the at least one illumination element.

21. The flasher controller of claim 18, wherein the circuit further comprises:
an internal clock generator for putting out a square-wave clock at a convenient frequency;
a clock prescaler, for reducing the frequency of the square-wave clock to a flashclock at a reasonable rate for flashing the at least one illumination element;
a counter that is clocked by the flashclock and having a period that is a reasonable interval for the coded sequence flashing of the at least one illumination element;
a decoder for decoding a number of states of the counter, the number of decoded states corresponding to the number of input signals present;
a plurality of OR gates to combine the at least one input signal, wherein each input signal has an assigned priority, to create intermediate signals, wherein at least the highest priority input signal is asserted as an intermediate signal; and
a plurality of AND gates to combine the intermediate signals with counter state signals from the decoder.

22. The flasher controller of claim 18, further comprising a programmable digital computer in communication with the at least one output signal element and the at least one illumination element, wherein the digital computer receives the at least one input signal and is further programmed to drive the at least one illumination element to flash in the at least one coded sequence.

23. A flasher controller for controlling long distance annunciation of the operating status of at least one article of outdoor equipment by generating a coded sequence for flashing at least one xenon strobe disposed in proximity to the equipment for providing status and/or diagnostic information of at least one component or system of the equipment to an observer at a remote location, comprising:
a circuit, wherein the circuit receives at least one input signal from the at least one component or system, processes the at least one input signal and generates the coded sequence of flashing, wherein the at least one xenon strobe is flashed according to the coded sequence and wherein the capability of establishing a hierarchy in the at least one input signal, wherein each input signal is assigned a priority and the input signal with the lowest priority is the input signal used to generate the coded sequence used to flash the at least one xenon strobe and wherein the circuit further comprises:
an internal clock generator for putting out a square-wave clock at a convenient frequency; and
a clock prescaler, for reducing the frequency of the square-wave clock to a flashclock at a reasonable rate for flashing the at least one xenon strobe;
a counter that is clocked by the flashclock and having a period that is a reasonable interval for the coded sequence flashing of the at least one xenon strobe;
a decoder for decoding a number of states of the counter, the number of decoded states corresponding to the number of input signals present;
a plurality of OR gates to combine the at least one input signal, each input signal having an assigned priority to create intermediate signals, wherein at least the highest priority input signal is asserted as an intermediate signal; and
a plurality of AND gates to combine the intermediate signals with counter state signals from the decoder.

24. A method for long-distance annunciation of the operating status of at least one article of outdoor equipment, comprising:
providing at least one signal output element in the equipment;
receiving at least one input signal from the at least one signal output element;
assigning a coded flash signal sequence to each input signal;
generating at least one coded flash sequence signal corresponding to the at least one input signal; and
flashing at least one illumination element in accordance with the at least one coded flash sequence signal.

25. The method of claim 24, further comprising assigning a priority to each at least one signal input.

26. The method of claim 25, further comprising determining which of the at least one signal inputs has the highest priority; and
generating a coded signal sequence corresponding to the highest priority signal input.

27. The method of claim 25, further comprising:
determining which of the at least one signal inputs has the lowest priority; and
generating a coded signal sequence corresponding to the lowest priority signal input.

28. The method of claim 25, further comprising:
generating a square-wave clock at a convenient frequency;
reducing the frequency of the square-wave clock to a flashclock;
clocking a counter by the flashclock;
decoding a number of states of the counter, wherein the number of decoded states correspond to the number of input signals;
combining the at least one input signal to create intermediate signals, wherein at least the highest priority input signal is asserted as an intermediate signal;
combining the intermediate signals with the decoded counter states to produce a coded signal sequence according to the highest priority input signal; and
flashing the at least one illumination element according to the coded signal sequence that corresponds with the highest priority input signal.

29. The method of claim 25, further comprising:
generating a square-wave clock at a convenient frequency;
reducing the frequency of the square-wave clock to a flashclock;
clocking a counter by the flashclock;
decoding a number of states of the counter, wherein the number of decoded states correspond to the number of input signals;
combining the at least one input signal to create intermediate signals, wherein at least the lowest priority input signal is asserted as an intermediate signal;
combining the intermediate signals with the decoded counter states to produce a coded signal sequence according to the lowest priority input signal; and
flashing the at least one illumination element according to the coded signal sequence that corresponds with the lowest priority input signal.

30. A programmed digital computer for long-distance annunciation of the operating status of at least one article of outdoor equipment, the equipment having at least one signal output elements and at least one illumination element, comprising:
a processor;
a memory operatively coupled to the processor;
a data input interface operatively coupled to the processor and memory;
a data output interface operatively coupled to the processor and memory;
wherein the programmed digital computer operates to receive at least one input signal from the at least one signal output element;
wherein the programmed digital computer operates to assign a coded flash sequence to each input signal and store the assigned sequences in the memory;
wherein the programmed digital computer operates to generate at least one coded flash sequence signal corresponding to the at least one input signal; and
wherein the programmed digital computer operates to flash an illumination element in accordance with the at least one coded flash sequence signal.

31. The programmed digital computer of claim 30, further comprising:
the programmed digital computer operating to assign a priority to each at least one signal input and wherein the programmed digital computer further determines which of the at least one signal inputs has the highest priority, and generates a coded signal sequence corresponding to the highest priority signal input.

32. The programmed digital computer of claim 30, further comprising:
the programmed digital computer operating to assign a priority to each at least one signal input and wherein the programmed digital computer further determines which of the at least one signal inputs has the lowest priority, and generates a coded signal sequence corresponding to the lowest priority signal input.

33. A computer program product for controlling the long-distance annunciation of the operating status of at least one article of outdoor equipment, comprising:
computer code for recognizing the receipt of at least one input signal from the at least one signal output element;
computer code for assigning a coded flash sequence to each input signal and store the assigned sequences in the memory;
computer code for generating at least one coded flash sequence signal corresponding to the at least one input signal; and
computer code for flashing an illumination element in accordance with the at least one coded flash sequence signal.

34. The computer program product of claim 33, further comprising:
computer code for assigning a priority to each at least one signal input;
computer code for determining which of the at least one signal inputs has the highest priority; and
computer code for generating a coded signal sequence corresponding to the highest priority signal input.

35. The computer program product of claim 33, further comprising:
computer code for assigning a priority to each at least one signal input;
computer code for determining which of the at least one signal inputs has the lowest priority; and
computer code for generating a coded signal sequence corresponding to the lowest priority signal input.
